(19) United States
(12) Patent Application Publication
(10) Pub. No.: US 2024/0252992 A1
(43) Pub. Date: Aug. 1, 2024

(54) ULTRA FINE BUBBLE-CONTAINING LIQUID PRODUCING METHOD, AND ULTRA FINE BUBBLE-CONTAINING LIQUID PRODUCING APPARATUS

(71) Applicant: CANON KABUSHIKI KAISHA, Tokyo (JP)

(72) Inventors: TAKAHARU AOTANI, Tokyo (JP); YOHEI MASADA, Tokyo (JP); IKUO NAKAZAWA, Kanagawa (JP)

(21) Appl. No.: 18/633,863

(22) Filed: Apr. 12, 2024

Related U.S. Application Data
(63) Continuation of application No. PCT/JP2022/030062, filed on Aug. 5, 2022.

(30) Foreign Application Priority Data
Oct. 29, 2021 (JP) 2021-177362

(51) Int. Cl. B01F 23/213; B01F 23/2373

(52) U.S. Cl. CPC B01F 23/213; B01F 23/2373

(57) ABSTRACT

Provided is a technology for efficiently producing an ultra fine bubble-containing liquid containing a predetermined gas. To this end, a droplet containing an ultra fine bubble containing a first gas is caused to fly through an atmosphere of a second gas different from the first gas.

### CROSS-REFERENCE TO RELATED APPLICATIONS

This application is a Continuation of International Patent Application No. PCT/JP2022/030062, filed Aug. 5, 2022, which claims the benefit of Japanese Patent Application No. 2021-177362, filed Oct. 29, 2021, both of which are hereby incorporated by reference herein in their entirety.

### BACKGROUND OF THE INVENTION

### Field of the Invention

The present disclosure relates to a technology for producing an ultra fine bubble-containing liquid.

### Background Art

In recent years, the utility of ultra fine bubbles (hereinafter also referred to as “UFBs”) smaller than 1.0 μm in diameter have been confirmed in various fields. Also, it has been reported that a UFB-containing liquid functions differently depending on the type of gas forming its UFBs. For example, it has been reported that using nitrogen as a gas forming UFBs provides an antiseptic effect and using oxygen provides a growth promoting effect. Moreover, it has been reported that containing ozone as a constituent gas can provide a sterilizing effect.

As a technology for producing such a UFB-containing liquid, PTL 1 discloses a fine bubble generating apparatus that jets a pressurized liquid in which a gas is dissolved by pressurization from a depressurizing nozzle to thereby generate fine bubbles containing that gas.

### CITATION LIST

### Patent Literature

PTL 1: Japanese Patent Laid-Open No. 2014-104441

### SUMMARY OF THE INVENTION

For the production of UFBs, the technology disclosed in PTL 1 employs a method in which air or a desired gas is dissolved in a liquid in advance to generate a gas-dissolved liquid, and then caused to precipitate in the form of UFBs. To generate the gas-dissolved liquid, bubbling is performed, in which case a large amount of the gas introduced in the liquid is released to the ambient air without dissolving into the liquid, so that the gas is wastefully consumed. This leads to a problem that the efficiency of production of the UFB-containing liquid is low.

An object of the present invention is to provide a technology for efficiently producing an ultra fine bubble-containing liquid containing a predetermined gas.

The present invention is an ultra fine bubble-containing liquid producing method comprising causing a droplet containing an ultra fine bubble containing a first gas to fly through an atmosphere of a second gas different from the first gas.

Further features of the present invention will become apparent from the following description of exemplary embodiments with reference to the attached drawings.

### BRIEF DESCRIPTION OF THE DRAWINGS

FIG. 1 is a diagram illustrating a schematic configuration of a UFB-containing liquid producing apparatus in an embodiment.

FIG. 2A is a diagram illustrating conceptual configurations of ejecting units in a UFB generating apparatus.

FIG. 2B is a diagram illustrating conceptual configurations of ejecting units in a UFB generating apparatus.

FIG. 2C is a diagram illustrating conceptual configurations of ejecting units in a UFB generating apparatus.

FIG. 3A is a diagram illustrating how gas exchange occurs between droplets and an atmosphere and how gas exchange occurs between the droplets and UFBs.

FIG. 3B is a diagram illustrating how gas exchange occurs between droplets and an atmosphere and how gas exchange occurs between the droplets and UFBs.

FIG. 3C is a diagram illustrating how gas exchange occurs between droplets and an atmosphere and how gas exchange occurs between the droplets and UFBs.

FIG. 4 is a schematic configuration diagram of a general UFB-containing liquid producing apparatus

FIG. 5 is a diagram illustrating a first modification of the UFB-containing liquid producing apparatus.

FIG. 6 is a diagram illustrating a second modification of the UFB-containing liquid producing apparatus.

FIG. 7 is a diagram illustrating conditions for production of a UFB-containing liquid in each of examples and results of the production.

### DESCRIPTION OF THE EMBODIMENTS

An embodiment of the present disclosure will be described in detail below with reference to the accompanying drawings. Note that the following embodiment does not limit the present invention according to the claims, and not all the combinations of the features described in this embodiment are necessarily essential for the solution to be provided by the present invention. Also, in the following description, bubbles with a diameter of less than 1.0 μm will also be referred to as “UFBs”, and an ultra fine bubble-containing liquid will also be referred to as “UFB-containing liquid”.

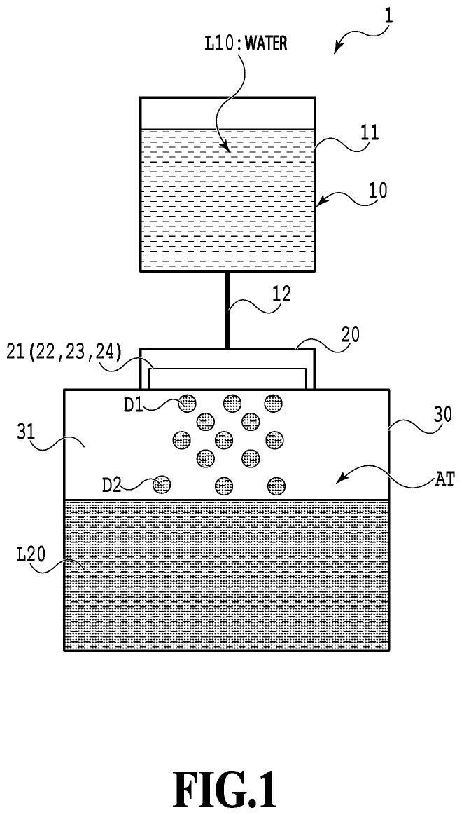

FIG. 1 is a diagram illustrating a schematic configuration of a UFB-containing liquid producing apparatus 1 in the present embodiment. The UFB-containing liquid producing apparatus 1 includes a supplying unit 10 that supplies a gas-dissolved liquid, a UFB generating apparatus 20, and a UFB-containing liquid collecting container (collection unit) 30. The gas-dissolved liquid supplying unit 10 in the present embodiment generates a gas-dissolved liquid (air-dissolved water) L10 by dissolving air (atmospheric air) into a liquid (water in this example) supplied to a supply container 11, and supplies the generated gas-dissolved liquid L10 to the UFB generating apparatus 20. The gas-dissolved liquid L10 is generated by introducing air into the liquid supplied in the supply container 11 with a bubbling mechanism not illustrated or the like and stirring the liquid. The gas-dissolved liquid L10 generated inside the supply container 11 is supplied to the UFB generating apparatus 20 through a supply channel 12. In the following description, the gas (air) dissolved in this gas-dissolved liquid L10 supplied to the UFB generating apparatus 20 will be referred to also as the first gas. Incidentally, in the present embodiment, a case of using air (atmospheric air) as an example of the first gas will be described, but the first gas is not limited to air and may be another gas.

The UFB generating apparatus 20 includes a plurality of ejecting units (ejection unit) 21 that eject the air-dissolved water L10 supplied from the supplying unit 10 in the form of minute droplets to generate UFBs in the droplets. The UFB generating apparatus 20 is provided at the top of the collecting container 30 and ejects many droplets D1 from the ejecting units 21 toward a hollow region 31 in the collecting container 30. The hollow region 31 in the collecting container 30 is filled with a predetermined gas different from the first gas (air) (hereinafter referred to also as the second gas), so that an atmosphere AT of the predetermined gas is formed. Thus, the collecting container 30 serves also as an atmosphere formation unit in which the atmosphere AT of the predetermined gas is formed.

Note that, in the present embodiment, a different gas means such a gas that at least one of its gas component or its gas concentration (partial pressure) is different. In other words, two gases are considered different gases in a case where one of the gases has a gas component different from that of the other gas. Also, in a case where one gas and another gas contain the same gas component but the concentration (partial pressure) of the gas component in the one gas and the concentration of the gas component in the other gas are different, the two gases are considered different from each other.

When the droplets D1 are ejected from the ejecting units 21, the liquid L10 undergoes an abrupt pressure change. In the droplets D1 ejected as a result of that pressure change, UFBs 100 are generated which contains air (first gas) as a gas component. The droplets D1 containing these UFBs 100 fly through the hollow region 31 in the collecting container 30, in which the atmosphere AT of the predetermined gas (second gas) is formed. During the flight through the atmosphere AT of the predetermined gas, gas exchange occurs between the gas component dissolved in the droplets D1 and the predetermined gas, so that the predetermined gas dissolves into the droplets D1. Furthermore, gas exchange occurs between the predetermined gas dissolved in the droplets D1 and the first gas (air) forming the UFBs present in the droplets D1, so that the UFBs become UFBs containing the second gas as a gas component. As a result, droplets D2 containing UFBs with the predetermined gas as a gas component are generated. These droplets D2 are collected and stored in the collecting container 30. A UFB-containing liquid L20 containing UFBs with the predetermined gas as a gas component is produced as described above.

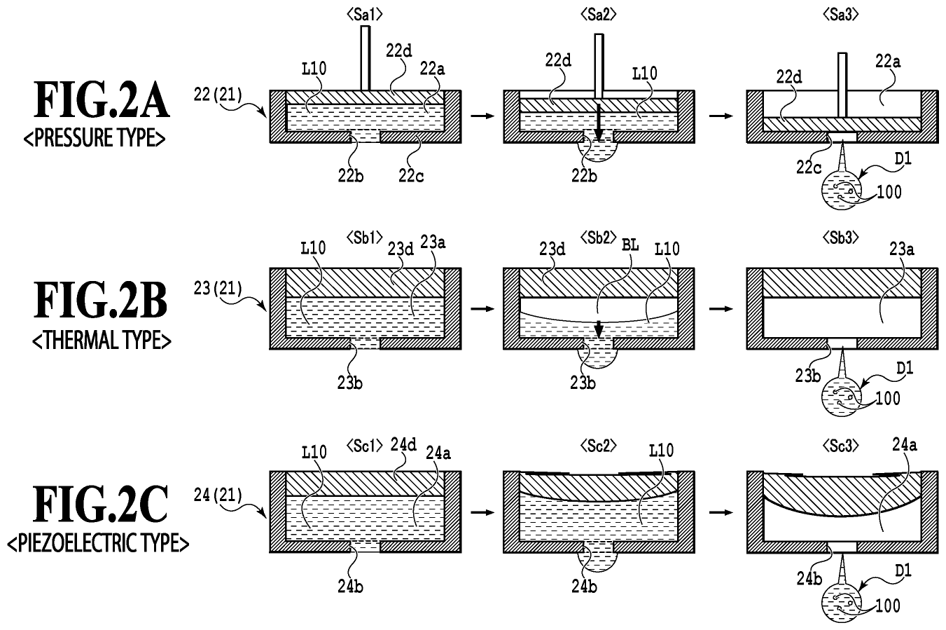

Now, the ejecting units 21 provided in the UFB generating apparatus 20 employed in the present embodiment will be described. FIGS. 2A to 2C are schematic diagrams illustrating conceptual configurations of three types of ejecting units 22 to 24 usable as the ejecting units 21 of the UFB generating apparatus 20 in the present embodiment. FIG. 2A illustrates a pressure-type ejecting unit 22, FIG. 2B illustrates a thermal-type ejecting unit 23, and FIG. 2C illustrates a piezoelectric-type ejecting unit 24.

The pressure-type ejecting unit 22 illustrated in FIG. 2A includes an ejection port forming member 22c in which are formed a plurality of minute ejection ports 22b for ejecting the liquid L10 supplied in a channel 22a in the form of droplets, and a pressurizing unit (pressure generation unit) 22d which applies a pressure to the liquid L10 inside the channel 22a. In the present embodiment, the ejection port forming member 22c has a metallic plate in which the plurality of ejection ports 22b are formed. The gas-dissolved liquid (liquid L10) supplied from the above-described supply container 11 (FIG. 1) is supplied into the channel 22a (Sa1). In the present embodiment, water in which air (a gas with an oxygen partial pressure of 21%) is dissolved to saturation is supplied as the gas-dissolved liquid into the channel 22a. The liquid L10 filled in the channel 22a is pressurized by the pressurizing unit 22d (Sa2). As a result, droplets D1 are ejected from the ejection ports 22b (Sa3). In this process of ejecting the droplets D1, the pressure on the liquid L10 (water pressure) rises immediately before the ejection from the ejection ports 22b. Then, the pressure on the liquid L10 drops when the liquid L10 is ejected to the outside from the ejection ports 22b in the form of the droplets D1. Thus, the liquid L10 undergoes an abrupt pressure change between before and after being the ejection from the ejection ports 22b. As a result, inside the droplets D1 made of the gas-dissolved liquid, the dissolved gas (air) is precipitated, thus generating UFBs 100 containing air as a gas component.

The thermal-type ejecting unit 23 illustrated in FIG. 2B includes a heating element 23d that converts electric energy into thermal energy as a pressure generation unit. In response to electric power supplied to the heating element 23d provided at a position facing ejection ports 23b in a state where a channel 23a is filled with the gas-dissolved liquid (liquid L10) (Sb1), the heating element 23d is heated, which in turn causes film boiling in the liquid L10 inside the channel 23a (Sb2). By the pressure from bubbles B1 generated by the film boiling, the liquid L10 inside the channel 23a is ejected from the ejection ports 23b in the form of droplets D1 (Sb3). The abrupt change in the pressure on the liquid L10 at this time generates UFBs 100 in the droplets D1. Also, in this thermal -type ejecting unit 23, the rise in the temperature of the liquid L10 and the shock wave generated in response to stoppage of the film boiling or the like are considered to contribute to the formation of the UFBs 100 in addition to the change in the pressure on the liquid L10 between before and after the ejection as described above.

Also, the piezoelectric-type ejecting unit 24 illustrated in FIG. 2C applies a voltage to a piezoelectric element 24d in a state where a channel 24a is filled with the gas-dissolved liquid (liquid L10) (Sc1). As a result, the piezoelectric element 24d gets deformed so as to pressurize the liquid L10 inside the channel 24a (Sc2) and eject droplets D1 from ejection ports 24b (Sc3). Due to the abrupt pressure change between before and after the ejection, UFBs 100 containing air as a gas component are generated inside the droplets D1.

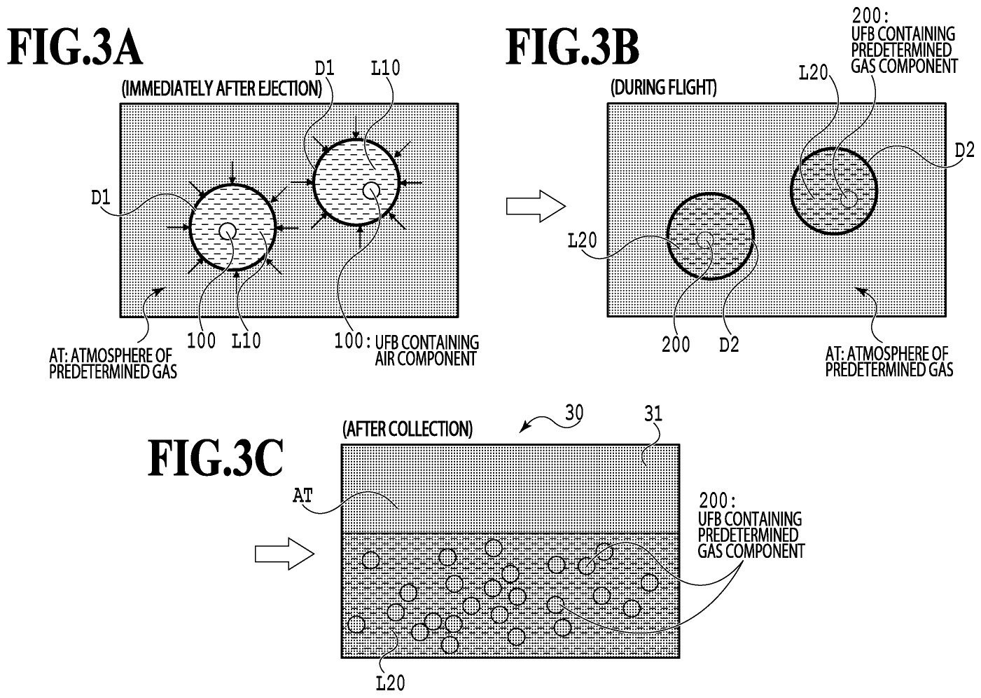

FIGS. 3A to 3C are diagrams illustrating how gas exchange occurs between droplets D1 and the atmosphere AT and how gas exchange occurs between the droplets D1 and the UFBs 100 contained in the droplets D1. As mentioned earlier, the collecting container 30 is filled with the predetermined gas, so that the atmosphere AT of the predetermined gas is formed. Many droplets D1 containing UFBs 100 are ejected from the ejecting units 21 into this atmosphere AT, thereby creating a misty state. FIG. 3A illustrates this state.

UFBs 100 containing air (first gas) as a gas component have been formed in the droplets D1 immediately after being ejected from the ejecting units 21. Here, during the flight through the hollow region 31, gas exchange occurs between the dissolved gas (air in this case) and the predetermined gas (second gas) forming the atmosphere AT due to equilibration of the partial pressures. The droplets D1 are minute and the surface area of the gas-liquid interface per volume (specific surface area) is large. Thus, this gas exchange occurs efficiently. Moreover, the predetermined gas (second gas) dissolved into the droplets D1 by the gas exchange also undergoes gas exchange with the gas component of the UFBs 100 formed inside the droplets D1 (air in this example), so that the droplets D1 become droplets D2 containing UFBs 200 containing the predetermined gas. FIG. 3B illustrates this state. The specific surface area of UFBs is extremely large, so that the UFBs can undergo gas exchange more efficiently. Then, the droplets D2 having flown through the hollow region 31 are collected in the collecting container 30 and, as illustrated in FIG. 3C, become a UFB-containing liquid L20 containing the UFBs 200 replaced with the predetermined gas.

Next, an example of producing a UFB-containing liquid will be more specifically described. In this section, a description will be given of an example of producing a UFB-containing liquid containing UFBs with a high concentration of oxygen by ejecting a UFB-containing liquid made of general-purpose purified water as a raw material in which atmospheric air is dissolved, and containing UFBs made of air (atmospheric air) by using the piezoelectric-type ejecting units 24 each illustrated in FIG. 2C into the collecting container 30 in which the oxygen partial pressure is 100%.

The liquid supplied to the ejecting units 24 is purified water in which atmospheric air (air) is dissolved. Thus, the partial pressure of the oxygen in the purified water before being ejected from the ejecting units 24 is 21%, and the amount of the dissolved oxygen at room temperature is 7.6 ppm. When this purified water is ejected in the form of droplets D1 into the collecting container 30, UFBs 100 made of atmospheric air are generated inside the droplets D1. As illustrated in FIG. 1, the droplets D1 containing these UFBs 100 fly through the hollow region 31 in the collecting container 30, and finally are collected in the collecting container 30 and become the UFB-containing liquid L20. The hollow region 31 in the collecting container 30 is filled with the atmosphere AT with an oxygen partial pressure of 100% in advance. In this way, gas exchange progresses between the atmosphere AT with an oxygen partial pressure of 100% and the droplets D1 with an oxygen partial pressure of 21% so as to equilibrate the oxygen partial pressures, so that the concentration of the dissolved oxygen in the droplets D1 rises. Moreover, as the concentration of the dissolved oxygen in the droplets D1 rises and the oxygen partial pressure rises, gas exchange occurs also between the droplets D1 and the UFBs 100 contained in those droplets D1. Specifically, the UFBs 100 before the gas exchange is atmospheric air, and the oxygen partial pressure is 21%. Thus, as the partial pressure of the oxygen in the droplets D1 rises as a result of the gas exchange with the atmosphere AT, gas exchange occurs also between the droplets D1 and the UFBs 100 so as to equilibrate the oxygen partial pressures. The specific surface area of the UFBs 100 is larger than the specific surface area of the droplets D1, the gas exchange between the droplets D1 and the UFBs 100 occurs more efficiently. In the present embodiment, the concentration of the dissolved oxygen in the fine bubble containing water collected in the collecting container 30 is 20 ppm (equivalent to an oxygen partial pressure of 50%). Thus, an oxygen-rich UFB-containing liquid (UFB-containing water) is produced, and UFBs 200 with a high concentration of oxygen are obtained.

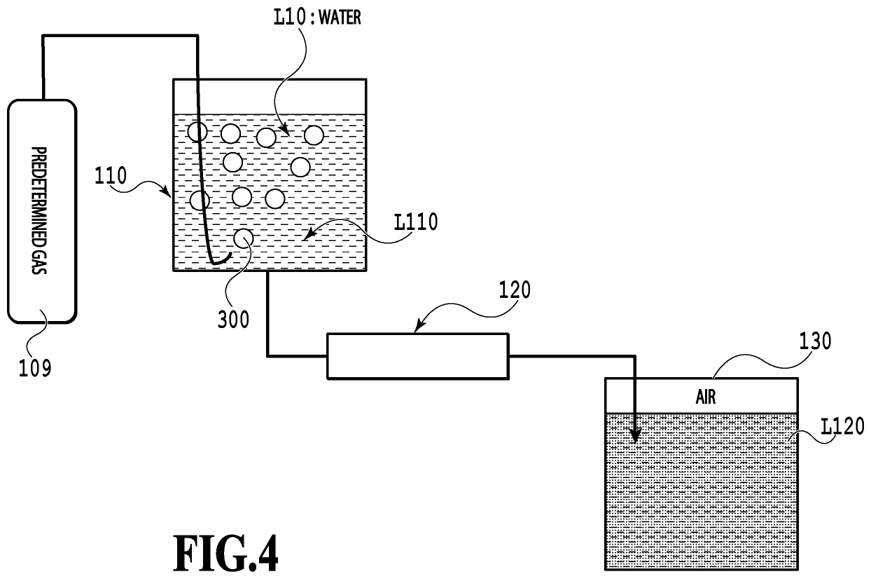

FIG. 4 is a schematic configuration diagram of a general UFB-containing liquid producing apparatus. This UFB-containing liquid producing apparatus performs bubbling by supplying a predetermined gas 300 into water stored in a supply container 110 from a high-pressure gas cylinder 109 to generate a gas-dissolved water L110. The UFB-containing liquid producing apparatus further supplies the generated gas-dissolved water L110 to a UFB generating apparatus 120, which generates UFBs to generate a UFB-containing liquid L120, and stores it in a predetermined collecting container 130. An existing UFB generating apparatus 120 is used as the UFB generating apparatus 120.

Such a UFB-containing liquid producing apparatus needs to perform bubbling by supplying the predetermined gas into the water L10 inside the supply container 110 from the high-pressure gas cylinder 109 to generate the gas-dissolved liquid L110, in which the predetermined gas is dissolved. This leads to a gas loss in which the predetermined gas 300 is released to the ambient air in the process of generating the gas-dissolved liquid L110. Accordingly, the generation efficiency of a gas-dissolved liquid in which the predetermined gas is dissolved at a desired concentration is low. In addition, the high-pressure gas cylinder 109 needs to be placed always, which may increase the size of the apparatus as a whole.

In contrast, the UFB-containing liquid producing apparatus 1 in the present embodiment illustrated in FIG. 1 ejects droplets D1 with a large specific surface area into the collecting container 30 filled with the predetermined gas to cause gas exchange between the droplets D1 and the atmosphere AT. In this way, it is possible to generate droplets D2 in which the predetermined gas (oxygen in the above example) is dissolved at a high concentration while reducing wasteful consumption of the predetermined gas. Moreover, inside the droplets D2, gas exchange also occurs between the predetermined gas dissolved at a high concentration and the UFBs 100 made of atmospheric air. In this way, it is possible to efficiently generate the UFB-containing liquid L20 containing UFBs 200 containing a high concentration of the predetermined gas.

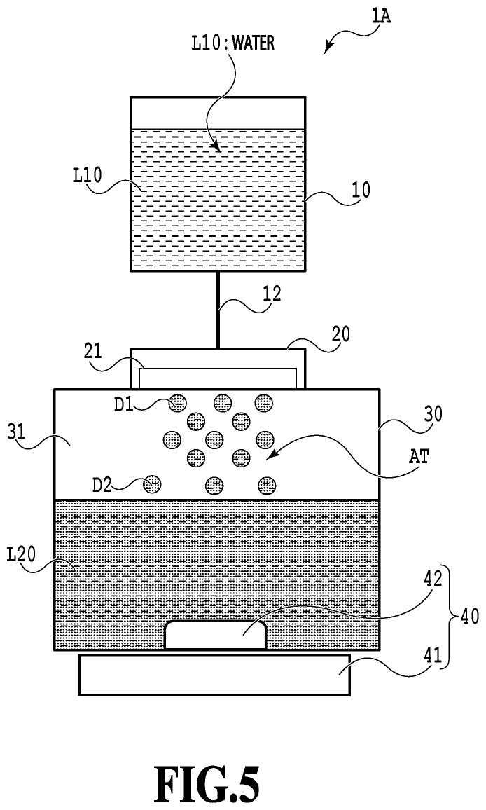

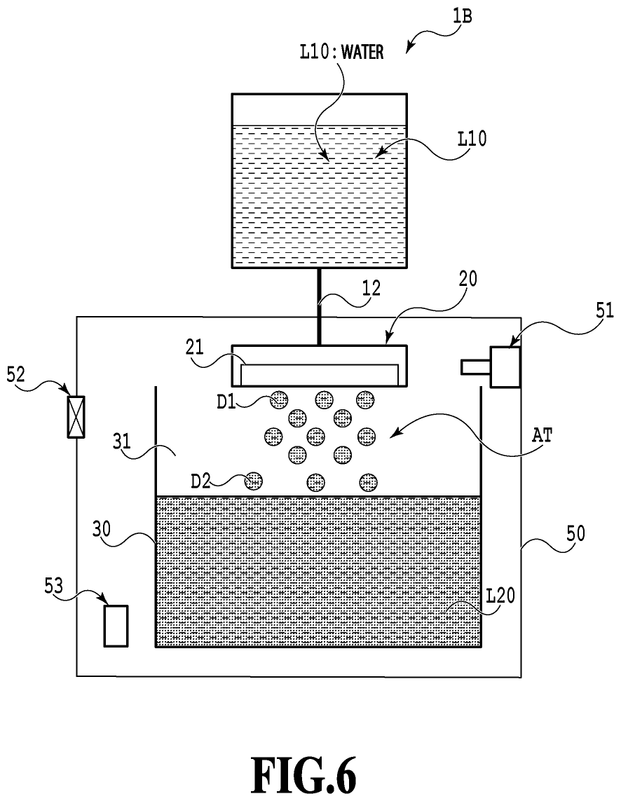

Next, modifications of the UFB-containing liquid producing apparatus 1 in the present embodiment illustrated in FIG. 1 will be described based on FIGS. 5 and 6.

### First Modification

FIG. 5 is a diagram illustrating a first modification of the UFB-containing liquid producing apparatus illustrated in FIG. 1. A UFB-containing liquid producing apparatus 1 A illustrated in FIG. 5 is the UFB-containing liquid producing apparatus 1 illustrated in FIG. 1 with a stirring mechanism (agitation unit) 40 provided to the collecting container 30. The stirring mechanism 40 includes a stirrer 41 provided on the outer surface of the bottom of the collecting container 30, and a stirring body 42 provided inside the collecting container 30. The stirrer 41 has a magnet that is rotated by a motor, and rotates the stirring body 42 inside the collecting container 30 with a magnetic field generated by the magnet. This rotation of the stirring body 42 stirs the UFB-containing liquid collected in the collecting container 30.

In the first modification too, like the above embodiment, droplets D2 containing UFBs 200 containing the predetermined gas are generated, and those droplets D2 are connected in the collecting container 30 and become the UFB-containing liquid L20. Moreover, in the first modification, the liquid L20 collected in the collecting container 30 is stirred by the stirring body 42. In this way, the gas exchange between the collected liquid L20 and the atmosphere AT at their interface progresses further. The gas exchange is dominated by the surface area of the interfaces between the liquid L20 and the UFBs 200 and the molecular motion around the interfaces. In a case where the liquid L20 stored in the collecting container 30 is left at rest, the gas concentration locally saturates at the surface layer of the gas-liquid interface, so that the gas tends not to dissolved any further. However, stirring the liquid stored in the collecting container 30 with the stirring body 42 as in the present modification prevents the localization of the gas concentration at the surface layer of the gas-liquid interface, so that the gas exchange between the liquid L20 and the atmosphere AT at their interface progresses further. Accordingly, the gas exchange between the UFBs 100 and 200 present inside the liquid L20 and the liquid L20 progresses further as well. Thus, in accordance with the present modification, it is possible to more efficiently produce a UFB-containing liquid containing a predetermined gas.

### Second Modification

FIG. 6 is a diagram illustrating a second modification of the UFB-containing liquid producing apparatus 1 illustrated in FIG. 1. A UFB-containing liquid producing apparatus 1B illustrated in FIG. 6 includes a storage chamber 50 a space to store the collecting container 30 and the UFB generating apparatus 20. The storage chamber 50 is supplied with the predetermined gas from a gas supplying unit 51 provided in an upper portion. The pressure inside the storage chamber 50 is maintained at a higher pressure (positive pressure) than the pressure outside the storage chamber 50 (the atmospheric pressure in this case). The collecting container 30 stored in the storage chamber 50 has an open top, and the hollow region 31 in the collecting container 30 communicates with the space in the storage chamber 50. Thus, like the space in the storage chamber 50, an atmosphere of the predetermined gas is formed inside the hollow region 31 in the collecting container 30. Also, a discharge window (gas discharge unit) 52 through which the gas can be discharged is formed in the wall of the upper portion of the storage chamber 50. Moreover, the storage chamber 50 is provided with a pressure gauge (pressure detection unit) 53 that detects the internal pressure. The supply of the gas from a gas supply source connected to the gas supplying unit 51 is controlled based on the pressure measured by this pressure gauge 53 so as to maintain the pressure inside the storage chamber 50 at a constant pressure (positive pressure).

In the UFB-containing liquid producing apparatus 1B in the present modification too, the atmosphere AT of the predetermined gas is formed in the hollow region 31 in the collecting container 30. Thus, as with the apparatus illustrated in FIG. 1, droplets D1 ejected from the UFB generating apparatus 20 are collected in the collecting container 30 after gas exchange between the ejected droplets D1 and the predetermined gas, so that a UFB-containing the liquid L20 containing the predetermined gas as a gas component is generated. Also, the gas discharged from the droplets D2 or the liquid L20 as a result of the gas exchange with the predetermined gas is released to the hollow region 31 in the collecting container 30 and the storage chamber 50. This gas will not remain in the storage chamber 50 or the collecting container 30 since it will be discharged to the outside through the discharge window 52 by the pressure difference between the storage chamber 50 and the outside pressure. Accordingly, the gas concentration of the predetermined gas in the collecting container 30 will gradually increase. Thus, the droplets ejected in the form of mist into the hollow region 31 in the collecting container 30 always undergo efficient gas exchange with the atmosphere AT of the predetermined gas supplied to the storage chamber 50.

Note that the predetermined gas filled into the collecting container 30 is not particularly limited. For example, hydrogen, helium, nitrogen, methane, fluorine, neon, carbon dioxide, ozone, argon, chlorine, ethane, propane, air, clean air, medical air, so on are preferable. Also, mixed gases of multiple components like air are usable as well.

### EXAMPLES

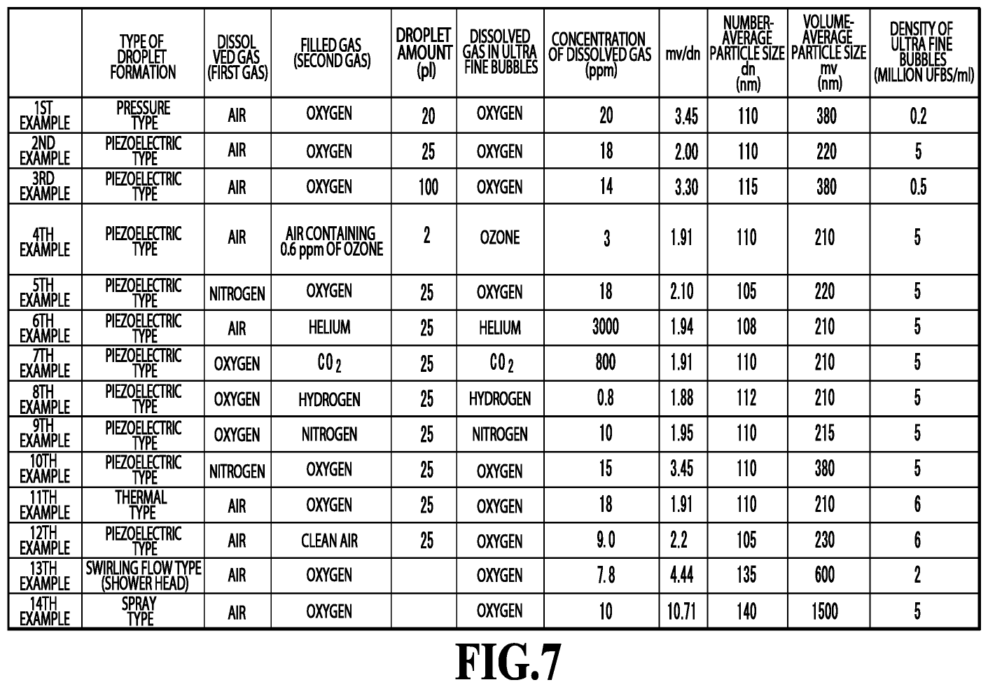

Specific examples of producing a UFB-containing liquid with the UFB-containing liquid producing apparatus described in the above embodiment will now be described in the following 1st to 14th examples. Incidentally, FIG. 7 illustrates conditions for the production of the UFB-containing liquid in each example and results of the production.

### First Example

In the first example, the UFB-containing liquid producing apparatus 1B illustrated in FIG. 5 was used to produce a UFB-containing liquid. The pressure-type ejecting unit 22 illustrated in FIG. 2A was used as each ejecting unit 21 for ejecting droplets. The ejecting unit 22 includes an ejection port forming member having a metallic plate in which are formed 2000 opening portions (ejection port 22b) capable of ejecting 50-μm droplets. A saturated aqueous solution L10 as a first liquid in which air was dissolved was supplied into the channel 22a in this ejecting unit 22, and the saturated aqueous solution L10 was pressurized by the pressurizing unit 22d to eject droplets D1 from the ejection ports 22b. The pressure applied to the saturated aqueous solution L10 by the pressurizing unit 22d at this time was a pressure of such a degree as to eject 20-pl droplets from each ejection port 22b. The droplets to be ejected from the ejection ports 22b are each preferably a droplet of 100 pl or less in order to achieve efficient gas exchange between the first gas (air in the present example) dissolved in the droplets immediately after being ejected from the ejection ports 22b and the second gas (oxygen in the present example) in the atmosphere AT inside the collecting container 30. Thus, in the present example, the pressure to be applied to the saturated solution L10 was set so as to eject droplets of about 20 pl from the ejection ports 22b.

On the other hand, the hollow region 31 in the collecting container 30 was filled with an oxygen gas as the predetermined gas (second gas). The droplets D1 ejected from the ejection ports 22b flew through the hollow region 31 in the collecting container 30 in the form of mist and were collected in the collecting container 30.

In the present example, the size of the droplets D1 and D2 that flew through the hollow region 31 in the collecting container 30 was calculated by microscope observation. From the calculation, it was confirmed that the volume of each ejected droplet was approximately 20 pl.

Moreover, the average particle size, and density, of the UFBs contained in the liquid collected in the collecting container 30 were measured. A measuring instrument manufactured by Shimadzu Corporation (model number: SALD-7500) was used for the measurement. The result of the measurement indicated that, the volume-average particle size (mv) and the number-average particle size (dn) of the UFBs were 380 nm and 110 nm, respectively, and the ratio between the two sizes (mv/dn) was 3.45. Also, the density of the UFBs in the UFB-containing liquid was 20 million UFBs/ml.

Incidentally, it is preferable for long-term storage stability that the UFBs have a volume-average particle size (mv) and number-average particle size (dn) of 20 μm or less and the ratio between the volume-average particle size (mv) and the number-average particle size (dn) (mv/dn) be 3.5 or less. In the present example, the measurement results of the UFBs satisfy the above preferable conditions. This means that UFBs with good long-term storage stability were generated.

Gas types were analyzed by using a dissolved oxygen meter (manufactured by Hach Company) for oxygen, a pack test (manufactured by KYORITSU CHEMICAL-CHECK Lab., Corp.) for ozone, and a gas chromatograph (manufactured by Shimadzu Corporation) for hydrogen, nitrogen, helium, and oxygen.

Also, the amount of the dissolved oxygen in the UFB-containing liquid L20 collected in the collecting container 30 was measured by the gas type analysis. From the measurement, it was confirmed that the amount of the dissolved oxygen in the collected UFB-containing liquid L20 was 20 ppm, representing a high concentration of oxygen contained as compared to the amount of the dissolved oxygen in the gas-dissolved the liquid L10 (8 ppm). This result revealed that at least part of the gas dissolved in the gas-dissolved the liquid L10 before being ejected in the form of droplets underwent gas exchange from air to oxygen during the flight through the oxygen atmosphere AT in the collecting container 30 in the form of droplets. Also, the concentration of the dissolved oxygen in the collected UFB-containing liquid L20 was higher than the solubility of oxygen in water. This revealed that the gas in the UFBs 200 contained in the UFB-containing the liquid L20 underwent gas exchange with oxygen.

Moreover, the collected UFB-containing the liquid L20 was stirred by rotating the stirring body 42 provided in the collecting container 30. This raised the concentration of the dissolved oxygen in the UFB-containing the liquid L20 to 25 ppm while maintaining the density and particle size of the UFBs. It was revealed that this rise in the concentration of the dissolved oxygen in the UFB-containing the liquid L20 allowed the gas exchange of the UFBs 200 contained in the UFB-containing the liquid L20 to progress further.

### Second Example

In the second example, each droplet ejecting unit in the UFB-containing liquid producing apparatus 1B used in the above first example was changed from the above ejecting unit 22 to the piezoelectric-type ejecting unit 24 illustrated in FIG. 2C. A piezoelectric ejecting apparatus (KJ-4B: manufactured by KYOCERA Corporation) was used as the piezoelectric-type ejecting unit 24. Also, the droplet amount of each of droplets D1 to be ejected from the ejection ports 24b in the ejecting unit 24 was set to 25 pl. A UFB-containing the liquid L20 was produced with the other production conditions set to the same conditions as those in the first example.

The density of the UFBs in the UFB-containing liquid L20 produced in the present example was 500 million UFBs/ml. Also, it was confirmed that oxygen was dissolved at a high concentration of 18 ppm in the UFB-containing the liquid L20. This result revealed that at least part of the gas dissolved in the droplets D1 underwent gas exchange from air to oxygen during the flight of the droplets D1 through the oxygen atmosphere AT in the collecting container 30. Also, the concentration of the dissolved oxygen in the collected UFB-containing liquid L20 was higher than the solubility of oxygen in water. This revealed that the gas in the UFBs 200 contained in the UFB-containing the liquid L20 underwent gas exchange from air to oxygen. Note that, in the present example, the UFBs 200 contained in the UFB-containing the liquid L20 had a volume-average particle size (mv) of 220 nm and a number-average particle size (dn) of 110 nm, and the ratio between the two particle sizes (mv/dn) was 2.00. This means that UFBs with good long-term storage stability were also generated in the present example.

### Third Example

In the third example, the UFB-containing liquid producing apparatus 1B used in the above second example produced a UFB-containing liquid L20 with the droplet amount of each droplet D1 set to 100 pl and with the other production conditions set to the same conditions as those in the second example.

The density of the UFBs in the UFB-containing liquid L20 produced in the present example was 50 million UFBs/ml. Also, it was confirmed that oxygen was dissolved at a high concentration of 14 ppm in the UFB-containing the liquid L20. This result revealed that at least part of the gas dissolved in the droplets D1 underwent gas exchange from air to oxygen during the flight of the droplets through the oxygen atmosphere AT in the collecting container 30. Also, in the present example too, the concentration of the dissolved oxygen in the collected UFB-containing liquid L20 was higher than the solubility of oxygen in water. This revealed that the gas in the UFBs contained in the UFB-containing the liquid L20 underwent gas exchange from air to oxygen. Note that, in the present example, the UFBs contained in the UFB-containing the liquid L20 had a volume-average particle size (mv) of 380 nm and a number-average particle size (dn) of 115 nm, and the ratio between the two particle sizes (mv/dn) was 3.30.

### Fourth Example

In the fourth example, the gas filled in the collecting container 30 of the UFB-containing liquid producing apparatus 1B used in the above second example was changed from oxygen to air containing 0.6 ppm of ozone, and the droplet amount was set to 2 pl. A UFB-containing the liquid L20 was produced with the other production conditions set to the same conditions as those in the second example.

The density of the UFBs in the UFB-containing liquid L20 produced in the present example was 500 million UFBs/ml. Also, it was confirmed that ozone was dissolved at a high concentration of 3 ppm in the UFB-containing the liquid L20. This result revealed that at least part of the gas dissolved in the droplets D1 underwent gas exchange from air to ozone-containing air in the flight of the droplets D1 through the ozone atmosphere AT in the collecting container 30. Also, the concentration of the dissolved ozone in the collected UFB-containing liquid L20 was higher than the solubility of ozone in water. This revealed that the gas in the UFBs 200 contained in the UFB-containing the liquid L20 underwent gas exchange from air to the ozone-containing air. Note that, in the present example, the UFBs contained in the UFB-containing the liquid L20 had a volume-average particle size (mv) of 210 nm and a number-average particle size (dn) of 110 nm, and the ratio between the two particle sizes (mv/dn) was 1.91. This means that UFBs with good long-term storage stability were also generated in the present example.

### Fifth Example

In the fifth example, the UFB-containing liquid producing apparatus 1B used in the above second example produced a UFB-containing liquid L20 with the dissolved gas in the gas-dissolved water L10 before UFB generation changed from air to nitrogen and with the other production conditions set to the same conditions as those in the second example.

The density of the UFBs in the UFB-containing liquid L20 produced in the present example was 500 million UFBs/ml. Also, it was confirmed that oxygen was dissolved at a high concentration of 18 ppm in the UFB-containing the liquid. This result revealed that at least part of the gas dissolved in the droplets D1 underwent gas exchange from nitrogen to oxygen in the flight of the droplets through the oxygen atmosphere AT in the collecting container 30. Also, the concentration of the dissolved oxygen in the collected UFB-containing liquid L20 was higher than the saturation solubility of oxygen in water. This revealed that the gas in the UFBs 200 contained in the UFB-containing the liquid L20 underwent gas exchange from nitrogen to oxygen. Note that, in the present example, the UFBs contained in the UFB-containing the liquid had a volume-average particle size (mv) of 220 nm and a number-average particle size (dn) of 105 nm, and the ratio between the two particle sizes (mv/dn) was 2.10. This means that UFBs with good long-term storage stability were also generated in the present example.

### Sixth Example

In the sixth example, the UFB-containing liquid producing apparatus 1B used in the above second example produced a UFB-containing liquid L20 with the gas filled in the collecting container 30 changed from oxygen to helium and with the other production conditions set to the same conditions as those in the second example.

The density of the UFBs in the UFB-containing liquid L20 produced in the present example was 500 million UFBs/ml. Also, it was confirmed that helium was dissolved at a high concentration of 3000 ppm in the UFB-containing the liquid. This result revealed that at least part of the gas dissolved in the droplets D1 underwent gas exchange from air to helium in the flight of the droplets D1 through the helium atmosphere in the collecting container 30. Also, the concentration of the dissolved helium in the collected UFB-containing liquid L20 was higher than the solubility of helium in water. This revealed that the gas in the UFBs 200 contained in the UFB-containing the liquid L20 underwent gas exchange from air to helium. Note that, in the present example, the UFBs contained in the UFB-containing the liquid had a volume-average particle size (mv) of 210 nm and a number-average particle size (dn) of 108 nm, and the ratio between the two particle sizes (mv/dn) was 1.94. This means that UFBs with good long-term storage stability were also generated in the present example.

### Seventh Example

In the seventh example, the gas dissolved in the gas-dissolved water L10 before UFB generation in the UFB-containing liquid producing apparatus 1B used in the above second example was changed from air to oxygen, and the gas filled in the collecting container 30 was changed from oxygen to carbon dioxide (CO2). A UFB-containing the liquid L20 was produced with the other production conditions set to the same conditions as those in the second example.

The density of the UFBs in the UFB-containing liquid L20 produced in the present example was 500 million UFBs/ml. Also, it was confirmed that carbon dioxide was dissolved at a high concentration of 800 ppm in the UFB-containing the liquid L20. This result revealed that at least part of the gas dissolved in the droplets D1 underwent gas exchange from oxygen to carbon dioxide in the flight of the droplets D1 through the carbon dioxide atmosphere in the collecting container 30. Also, the concentration of the dissolved carbon dioxide in the collected UFB-containing liquid L20 was higher than the solubility of carbon dioxide in water. This revealed that the gas in the UFBs 200 contained in the UFB-containing the liquid L20 underwent gas exchange from oxygen to carbon dioxide. Note that, in the present example, the UFBs contained in the UFB-containing the liquid L20 had a volume-average particle size (mv) of 210 nm and a number-average particle size (dn) of 110 nm, and the ratio between the two particle sizes (mv/dn) was 1.91. This means that UFBs with good long-term storage stability were also generated in the present example.

### Eighth Example

In the eighth example, the gas dissolved in the gas-dissolved water L10 before UFB generation in the UFB-containing liquid producing apparatus 1B used in the above second example was changed from air to oxygen, and the gas filled in the collecting container 30 was changed from oxygen to hydrogen. A UFB-containing the liquid L20 was produced with the other production conditions set to the same conditions as those in the second example.

The density of the UFBs in the UFB-containing liquid L20 produced in the present example was 500 million UFBs/ml. Also, it was confirmed that hydrogen was dissolved at a high concentration of 0.8 ppm in the UFB-containing the liquid L20. This result revealed that at least part of the gas dissolved in the droplets D1 underwent gas exchange from oxygen to hydrogen in the flight of the droplets D1 through the hydrogen atmosphere in the collecting container 30. Also, the concentration of the dissolved hydrogen in the collected UFB-containing liquid L20 was higher than the solubility of hydrogen in water. This revealed that the gas in the UFBs 200 contained in the UFB-containing the liquid L20 underwent gas exchange from oxygen to hydrogen. Note that, in the present example, the UFBs contained in the UFB-containing the liquid L20 had a volume-average particle size (mv) of 210 nm and a number-average particle size (dn) of 112 nm, and the ratio between the two particle sizes (mv/dn) was 1.88. This means that UFBs with good long-term storage stability were also generated in the present example.

### Ninth Example

In the ninth example, the gas dissolved in the gas-dissolved water L10 before UFB generation in the UFB-containing liquid producing apparatus 1B used in the above second example was changed from air to oxygen, and the gas filled in the collecting container 30 was changed from oxygen to nitrogen. A UFB-containing the liquid L20 was produced with the other production conditions set to the same conditions as those in the second example.

The density of the UFBs in the UFB-containing liquid L20 generated in the present example was 500 million UFBs/ml. Also, it was confirmed that nitrogen was dissolved at a high concentration of 10 ppm in the UFB-containing the liquid L20. This result revealed that at least part of the gas dissolved in the droplets D1 underwent gas exchange from oxygen to nitrogen in the flight of the droplets D1 through the nitrogen atmosphere in the collecting container 30. Also, the concentration of the dissolved nitrogen in the collected UFB-containing liquid L20 was higher than the solubility of nitrogen in water. This revealed that the gas in the UFBs 200 contained in the UFB-containing the liquid L20 underwent gas exchange from oxygen to nitrogen. Note that, in the present example, the UFBs 200 contained in the UFB-containing the liquid L20 had a volume-average particle size (mv) of 215 nm and a number-average particle size (dn) of 110 nm, and the ratio between the two particle sizes (mv/dn) was 1.95. This means that UFBs with good long-term storage stability were also generated in the present example.

### 10th Example

In the 10th example, the gas dissolved in the gas-dissolved water L10 before UFB generation in the UFB-containing liquid producing apparatus used in the above 2nd example was changed from air to nitrogen. A UFB-containing the liquid L20 was produced with the other production conditions set to the same conditions as those in the second example.

The density of the UFBs in the UFB-containing liquid L20 generated in the present example was 500 million UFBs/ml. Also, it was confirmed that oxygen was dissolved at a high concentration of 15 ppm in the UFB-containing the liquid L20. This result revealed that at least part of the gas dissolved in the droplets D1 underwent gas exchange from nitrogen to oxygen in the flight of the droplets D1 through the oxygen atmosphere in the collecting container 30. Also, the concentration of the dissolved oxygen in the collected UFB-containing liquid L20 was higher than the solubility of oxygen in water. This revealed that the gas in the UFBs 200 contained in the UFB-containing the liquid L20 underwent gas exchange from nitrogen to oxygen. Note that, in the present example, the UFBs 200 contained in the UFB-containing the liquid L20 had a volume-average particle size (mv) of 380 nm and a number-average particle size (dn) of 110 nm, and the ratio between the two particle sizes (mv/dn) was 3.45. This means that UFBs with good long-term storage stability were also generated in the present example.

### 11th Example

In the 11th example, each ejecting unit 21 for ejecting droplets D1 in the UFB-containing liquid producing apparatus 1B used in the above second example was changed from the above piezoelectric-type ejecting unit 24 to the thermal-type ejecting unit 23 illustrated in FIG. 2B using the heating element 23d. A UFB-containing the liquid L20 was produced with the other production conditions set to the same conditions as those in the second example.

The density of the UFBs in the UFB-containing liquid L20 produced in the present example was 600 million UFBs/ml. Also, it was confirmed that oxygen was dissolved at a high concentration of 18 ppm in the UFB-containing the liquid L20. This result revealed that at least part of the gas dissolved in the droplets D1 underwent gas exchange from air to oxygen in the flight of the droplets D1 through the oxygen atmosphere AT in the collecting container 30. Also, the concentration of the dissolved oxygen in the collected UFB-containing liquid L20 was higher than the solubility of oxygen in water. This revealed that the gas in the UFBs 200 contained in the UFB-containing the liquid L20 underwent gas exchange from air to oxygen. Note that, in the present example, the UFBs 200 contained in the UFB-containing the liquid L20 had a volume-average particle size (mv) of 210 nm and a number-average particle size (dn) of 110 nm, and the ratio between the two particle sizes (mv/dn) was 1.91. This means that UFBs with good long-term storage stability were also generated in the present example.

### 12th Example

In the 12th example, the gas filled in the collecting container 30 of the UFB-containing liquid producing apparatus 1B used in the above second example was changed from oxygen to clean air. Clean air has a higher oxygen concentration than that of air dissolved in water. A UFB-containing the liquid L20 was produced with the other production conditions set to the same conditions as those in the second example.

The density of the UFBs in the UFB-containing liquid L20 generated in the present example was 600 million UFBs/ml. It was confirmed that oxygen was dissolved in the UFB-containing liquid L20 at a higher concentration (9.0 ppm) than the oxygen concentration in the air dissolved in the liquid L10. This result revealed that the gas dissolved in the droplets D1 underwent gas exchange from air to the clean air in the collecting container 30 in the flight of the droplets D1 through the clean air. Also, the concentration of the dissolved oxygen in the collected UFB-containing liquid L20 was higher than the solubility of oxygen in water. This revealed that the gas in the UFBs contained in the UFB-containing the liquid L20 (air) underwent gas exchange with clean air. Note that, in the present example, the UFBs 200 contained in the UFB-containing the liquid L20 had a volume-average particle size (mv) of 230 nm and a number-average particle size (dn) of 105 nm, and the ratio between the two particle sizes (mv/dn) was 2.2. This means that UFBs with good long-term storage stability were also generated in the present example.

### 13th Example

In the 13th example, a shower head (trade name: Bollina manufactured by Tanaka Metal Factory Co., Ltd.) was used as the ejecting units 21 for ejecting droplets D1, and water in which air (atmospheric air) was dissolved to saturation was ejected from the shower head into the collecting container filled with oxygen as a predetermined gas, and was then collected. This shower head employs a swirling flow system that generates fine bubbles by repetitively splitting and merging a gas-mixed liquid with a blending unit. Also, oxygen was filled in the collecting container 30.

In this 13th example, it was confirmed by photography that droplets ejected from the shower head included droplets of sizes greater than 100 pl. The density of the UFBs contained in the collected liquid was 200 million UFBs/ml.

It was confirmed that a high concentration of oxygen (oxygen concentration of 7.8 ppm) was dissolved in the UFB-containing the liquid L20 collected in the collecting container 30. This result revealed that the gas dissolved in the droplets D1 underwent gas exchange from air to oxygen in the flight of the droplets D1 through the oxygen atmosphere in the collecting container 30. Also, the concentration of the dissolved oxygen in the collected UFB-containing liquid L20 was 7.8 and higher than the solubility of oxygen in water, which is 7.6. This revealed that the gas in the UFBs 200 contained in the UFB-containing the liquid L20 underwent gas exchange from air to the clean air. Note that, in the present comparative example, the UFBs contained in the UFB-containing the liquid L20 had a volume-average particle size (mv) of 600 nm and a number-average particle size (dn) of 135 nm, and the ratio between the two particle sizes (mv/dn) was 4.44.

As described above, in the 13th example too, it was revealed that the gas component in the droplets ejected in the collecting container 30 underwent gas component from air to oxygen, so that the gas component in the UFBs in the droplets D1 also underwent gas exchange from air to oxygen. Note that the droplets ejected from the shower head included droplets of sizes greater than 100 pl, and the gas exchange did not easily progress with those droplets since their small specific surface areas were small. Thus, the concentration of the dissolved oxygen in the UFB-containing liquid dropped as compared to that in the second example. Moreover, the ejected droplets included bubbles other than UFBs, e.g., micro-bubbles and milli-bubbles. These may have floated to and disappeared at the liquid surface in the collecting container over time, and UFBs may have disappeared due to this.

### 14th Example

In the 14th example, a spray-type ejecting unit was used as each ejecting unit 21 for ejecting droplets D1. Specifically, water in which air was dissolved to saturation was ejected with a spray (trade name: e-3X manufactured by MTG Co., Ltd.) and then collected. The collecting container 30 was filled with oxygen as a predetermined gas. It was confirmed by photography that the droplets ejected from the spray included droplets of sizes greater than 100 pl.

The density of the UFBs contained in the collected liquid was 500 million UFBs/ml. It was confirmed that oxygen was dissolved at a high concentration of 10.71 ppm in this UFB-containing the liquid L20. This result revealed that the gas dissolved in the droplets D1 underwent gas exchange from air to oxygen in the flight of the droplets D1 through the oxygen atmosphere in the collecting container 30. Also, the concentration of the dissolved oxygen in the collected UFB-containing liquid L20 was higher than the solubility of oxygen in water. This revealed that the gas in the UFBs 200 contained in the UFB-containing the liquid L20 underwent gas exchange from air to oxygen. Also, in the present comparative example, the UFBs 200 contained in the UFB-containing the liquid L20 had a volume-average particle size (mv) of 1500 nm and a number-average particle size (dn) of 140 nm, and the ratio between the two particle sizes (mv/dn) was 10.71.

As described above, in the present example too, it was revealed that the gas component in the droplets D1 ejected in the collecting container 30 underwent gas component from air to oxygen, so that the gas component in the UFBs in the droplets D1 also underwent gas exchange from air to oxygen. Note that the droplets ejected from the spray included droplets of sizes greater than 100 pl. The gas exchange did not easily progress with those droplets since their small specific surface areas were small. Thus, the concentration of the dissolved oxygen in the UFB-containing liquid dropped as compared to that in the second example. Moreover, the ejected droplets included bubbles other than UFBs, e.g., micro-bubbles and milli-bubbles. Thus, these may have floated to and disappeared at the liquid surface in the collecting container over time, and UFBs may have disappeared due to this. In sum, the droplets are preferably 100 pl or less.

As described above, in the 1st to 14th examples, minute droplets containing UFBs were caused to fly through an atmosphere of a predetermined gas. This makes it possible to produce a UFB-containing liquid containing UFBs with the predetermined gas as a gas component. As compared to the conventional producing method in which a UFB-containing liquid is produced by dissolving the predetermined gas into a liquid and then generating UFBs in the gas-dissolved liquid, this method can reduce the predetermined gas that is released and lost and thus produce a UFB-containing liquid significantly efficiently.

### Other Embodiments

In the above embodiment and the above examples, instances have been presented in which droplets containing UFBs are caused to fly through an atmosphere of a predetermined gas to force the UFBs in the droplets to undergo gas exchange with the predetermined gas, and the UFB-containing liquid after that gas exchange is collected in a collecting container. However, the above embodiment and the above examples are not limited to these. The droplets having flown through the atmosphere of the predetermined gas can be directly applied to the UFB-containing liquid's application target without being collected in the collecting container.

Also, in the above embodiment and the above examples, instances have been presented in which the pressure change at the time of ejecting droplets from the minute ejection ports causes the gas dissolved in the droplets to precipitate to generate ultra fine bubbles. However, the above embodiment and the above examples are not limited to these. UFBs may be generated by a predetermined method in a gas-dissolved liquid in which the first gas, such as air, has been dissolved in advance to thereby generate a UFB-containing liquid, and this UFB-containing liquid may be ejected in the form of droplets from ejection ports with a minute diameter to cause these droplets to fly through an atmosphere of a predetermined gas (second gas). In this case too, it is possible to cause gas exchange between the droplets containing the first gas and the atmosphere of the predetermined gas (second gas) and also between the droplets after the gas exchange and the UFBs contained in the droplets. In sum, it is possible to generate a UFB-containing liquid containing UFBs containing the second gas.

In accordance with the present invention, it is possible to efficiently produce an ultra fine bubble-containing liquid containing a predetermined gas.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An ultra fine bubble-containing liquid producing method comprising:
causing a droplet containing an ultra fine bubble containing a first gas to fly through an atmosphere of a second gas different from the first gas.

2. The ultra fine bubble-containing liquid producing method according to claim 1, wherein
the second gas in the atmosphere contains a predetermined gas component different from the first gas, and
the ultra fine bubble contained in the droplet having flown through the atmosphere contains the predetermined gas component.

3. The ultra fine bubble-containing liquid producing method according to claim 1, wherein
the second gas in the atmosphere contains a same gas component as the first gas at a different concentration, and
the concentration in the ultra fine bubble contained in the droplet changes to a concentration different from that of the first gas as a result of flying through the atmosphere.

4. The ultra fine bubble-containing liquid producing method according to claim 1, further comprising collecting the droplet having flown through the atmosphere with a collection unit.

5. The ultra fine bubble-containing liquid producing method according to claim 4, wherein
the collection unit includes a collecting container filled with the second gas to form the atmosphere, and
the collecting container collects the droplet having flown through the atmosphere. 6 The ultra fine bubble-containing liquid producing method according to claim 5, wherein the collection unit further includes an agitation unit that agitates an ultra fine bubble-containing liquid made of the droplet collected in the collecting container.

7. The ultra fine bubble-containing liquid producing method according to claim 5, wherein the collecting container is stored in a storage chamber, and the first gas is supplied in a space inside the storage chamber to form an atmosphere of the first gas on an inside of the storage chamber and an inside of the collecting container communicating with the storage chamber.

8. The ultra fine bubble-containing liquid producing method according to claim 7, wherein the storage chamber has
a gas supplying unit that supplies the second gas from an outside, and
a gas discharging unit that discharges a gas inside the storage chamber to an outside.

9. The ultra fine bubble-containing liquid producing method according to claim 8, wherein the second gas is supplied from the gas supplying unit such that a pressure inside the storage chamber is higher than a pressure outside the storage chamber.

10. The ultra fine bubble-containing liquid producing method according to claim 1, wherein the droplet is generated by ejecting a liquid in which the first gas is dissolved from an ejection port with a minute diameter provided in an ejecting unit.

11. The ultra fine bubble-containing liquid producing method according to claim 10, wherein the ultra fine bubble is generated by a change in a pressure on the liquid that occurs between before and after ejection of the liquid in the form of the droplet from the ejection port.

12. The ultra fine bubble-containing liquid producing method according to claim 10, wherein the ejecting unit ejects a liquid containing an ultra fine bubble containing the first gas from the ejection port into the atmosphere in the form of a droplet to cause the droplet to fly through the atmosphere.

13. The ultra fine bubble-containing liquid producing method according to claim 10, wherein the ejecting unit has
an ejection port forming member in which the ejection port is formed, and
a pressurizing unit that pressurizes the liquid in which the first gas is dissolved to eject a droplet from the ejection port.

14. The ultra fine bubble-containing liquid producing method according to claim 10, wherein the ejecting unit includes a piezoelectric element that applies a pressure for ejecting the droplet from the ejection port to the liquid in which the first gas is dissolved.

15. The ultra fine bubble-containing liquid producing method according to claim 10, wherein the ejecting unit includes a heating element that generates thermal energy for ejecting the droplet from the ejection port in the liquid in which the first gas is dissolved.

16. The ultra fine bubble-containing liquid producing method according to claim 10, wherein the ejecting unit has a plurality of the ejection ports.

17. The ultra fine bubble-containing liquid producing method according to claim 1, wherein the droplet is a droplet of 100 pl or less.

18. The ultra fine bubble-containing liquid producing method according to claim 1, wherein
the ultra fine bubble has a volume-average particle size (mv) and number-average particle size (dn) of 20 μm or less, and
a ratio between the volume-average particle size (mv) and the number-average particle size (dn) (mv/dn) is 3.5 or less.

19. The ultra fine bubble-containing liquid producing method according to claim 1, wherein the second gas contains at least one of oxygen, nitrogen, ozone, carbon dioxide, or hydrogen as a gas component.

20. An ultra fine bubble-containing liquid producing apparatus comprising:
an ejection unit which ejects a droplet containing an ultra fine bubble containing a first gas; and
an atmosphere formation unit in which an atmosphere of a second gas different from the first gas is formed, wherein
the ejection unit ejects the droplet into the atmosphere to cause the droplet to fly through the atmosphere.
